(19) United States
(12) Patent Application Publication
(10) Pub. No.: US 2022/0083614 A1
(43) Pub. Date: Mar. 17, 2022

(54) METHOD FOR TRAINING A MACHINE LEARNING ALGORITHM (MLA) TO GENERATE A PREDICTED COLLABORATIVE EMBEDDING FOR A DIGITAL ITEM

(71) Applicant: YANDEX EUROPE AG, Luzern (CH)

(72) Inventors: Dmitry Valerevich USHANOV, Moscow (RU); Dmitry Andreevich KONDRASHKIN, Moscow (RU); Andrey Vadimovich ZIMOVNOV, Moscow (RU)

(21) Appl. No.: 17/233,154

(22) Filed: Apr. 16, 2021

(30) Foreign Application Priority Data
Sep. 15, 2020 (RU) 2020130363

(51) Int. Cl. G06F 16/9535; G06N 20/00; G06F 16/9536; G06K 9/62; G06F 16/9538

(52) U.S. Cl. CPC G06F 16/9535; G06N 20/00; G06F 16/9538; G06K 9/6256; G06F 16/9536

(57) ABSTRACT

Methods and servers for training a Machine Learning Algorithm (MLA) to generate predicted collaborative embeddings are disclosed. The method includes generating a training set for a training item which includes (i) a target collaborative embedding generated by an other MLA based on previous user-item interactions that are sufficient for generating the target collaborative embedding, (ii) the training item. During a given training iteration of the MLA, the server (i) inputs the training item into the MLA that generates a predicted collaborative embedding, (ii) determines a penalty score by comparing the predicted collaborative embedding generated by the MLA and the target collaborative embedding generated by the other MLA, and (iii) adjusts the MLA using the penalty score so as to increase the similarity between the predicted collaborative embedding and the target collaborative embedding of the training item.

### CROSS-REFERENCE

The present application claims priority from Russian Patent Application No. 2020130363, entitled “Method for Training a Machine Learning Algorithm (MLA) to Generate a Predicted Collaborative Embedding for a Digital Item”, filed on Sep. 15, 2020, the entirety of which is incorporated herein by reference.

### FIELD

The present technology relates to computer-implemented recommendation systems in general and specifically to methods and systems for training a Machine Learning Algorithm (MLA) to generate a predicted collaborative embedding for a digital item.

### BACKGROUND

Various global or local communication networks (the Internet, the World Wide Web, local area networks, and the like) offer a user a vast amount of information. The information includes a multitude of contextual topics, such as but not limited to, news and current affairs, maps, company information, financial information and resources, traffic information, games, and entertainment-related information. Users use a variety of client devices (desktop, laptop, notebook, smartphone, tablets, and the like) to have access to rich content (like images, audio, video, animation, and other multimedia content from such networks).

The volume of available information through various Internet resources has grown exponentially in the past couple of years. Several solutions have been developed in order to allow a typical user to find the information that the user is looking for. One example of such a solution is a search engine. Examples of the search engines include GOOGLE™ search engine, YANDEX™ search engine, YAHOO!™ search engine and the like. The user can access the search engine interface and submit a search query associated with the information that the user is desirous of locating on the Internet. In response to the search query, the search engine provides a ranked list of search results. The ranked list of search results is generated based on various ranking algorithms employed by the particular search engine that is being used by the user performing the search. The overall goal of such ranking algorithms is to present the most relevant search results at the top of the ranked list, while less relevant search results would be positioned on less prominent positions of the ranked list of search results (with the least relevant search results being located towards the bottom of the ranked list of search results).

The search engines typically provide a good search tool for a search query that the user knows apriori that she/he wants to search. In other words, if the user is interested in obtaining information about the most popular destinations in Italy (i.e. a known search topic), the user could submit a search query: “The most popular destinations in Spain?” The search engine will then present a ranked list of Internet resources that are potentially relevant to the search query. The user can then browse the ranked list of search results in order to obtain the information she/he is interested in as it related to places to visit in Spain. If the user, for whatever reason, is not satisfied with the uncovered search results, the user can re-run the search, for example, with a more focused search query, such as “The most popular destinations in Spain in the summer?”, “The most popular destinations in the South of Spain?”, “The most popular destinations for a culinary getaway in Spain?”.

There is another approach that has been proposed for allowing the user to discover content and, more precisely, to allow for discovering and/or recommending content that the user may not be expressly interested in searching for. In a sense, such systems recommend content to the user without an express search request based on the explicit or implicit interests of the user.

An example of such a system is a FLIPBOARD™ recommendation system, which system aggregates and recommends content from various sources, where the user can “flip” through the pages with the recommended/aggregated content. The recommendation system collects content from social media and other websites, presents it in magazine format, and allows users to “flip” through their social-networking feeds and feeds from websites that have partnered with the company, effectively “recommending” content to the user even though the user may not have expressly expressed her/his desire in the particular content.

Another example of the recommendation system is YANDEX.ZEN™ recommendation system. The Yandex.Zen recommendation system recommends digital content (such as articles, news, and video in a personalized feed on the Yandex.Browser start screen). As the user browses the Yandex.Zen server recommended content, the server acquires explicit (by asking whether the user likes to see more of such content in the user's feed) or implicit (by observing user content interactions) feedback. Using the user feedback, the Yandex.Zen server continuously improves the content recommendations presented to the given user.

### SUMMARY

It is an object of the present technology to ameliorate at least some of the inconveniences present in the prior art. Embodiments of the present technology may provide and/or broaden the scope of approaches to and/or methods of achieving the aims and objects of the present technology.

It has been appreciated by the developers of the present technology that the selection of relevant digital content for users of a recommendation service requires a significant amount of processing power during the online operation thereof (i.e. when a content recommendation request is received from a given user of the recommendation service). State of the art relevance estimation models may be employed for processing a large amount of digital content in an on-line mode for determining which digital content should be provided to given users of the recommendation service. However, the execution of these state-of-the-art relevance estimation models is computationally expensive due to the large amount and variety of factors that should be taken into account for estimating relevance of the digital content, and results in an important processing power requirement on the recommendation system while operating online.

It should also be appreciated that the estimation of user interaction data is a significant problem in the art since it is generally used for recommending digital content to users of the recommendation service. Indeed, a given user typically does not interact with all digital items of the recommendation service. Therefore, user interaction data is somewhat “sparse” to the extent where it is difficult to properly estimate the relevance of some digital content to given users since these users have not interacted with some digital content and the recommendation system does not have much information to draw from in order to determine whether some digital content would be appreciated by given users if it is recommended thereto.

Developers of the present technology have devised methods and systems for overcoming at least some drawbacks of the prior art. In at least some non-limiting embodiments of the present technology, there are provided methods and systems that allow estimating a “collaborative” item-specific embedding for a given item, even if the system has access to insufficient user-item interaction data for that item (due to sparseness).

The developers of the present technology have devised some aspects of the present technology which allow leveraging Transfer Learning (TL) techniques in order to perform such estimation of the item-specific embedding of collaborative type, when collaborative type data for a given item is too sparse and/or insufficient for generating such embedding via matrix factorization models, for example. Broadly speaking, TL is a branch of Machine Learning which focuses on storing knowledge gained while solving one problem and applying it to a different, but related problem. As it will become apparent from the description herein further below, developers of the present technology have devised methods and systems where content data, which is typically used for performing content-based filtering techniques on recommendation content, is used to predict collaborative embeddings that are to be used for performing collaborative filtering techniques on recommendation content. Indeed, using content data (e.g., raw textual data) for generating predicted item-specific embeddings of collaborative type may allow the use of collaborative filtering techniques on content for which limited collaborative information is available.

It should be noted that in some embodiments of the present technology, the developers of the present technology have devised methods and servers for training a TL based MLA to predict item-specific embeddings of collaborative type based on content data from the items, even if limited user-item interaction data is available for those items. In some non-limiting embodiments, the TL based MLA may be used in an off-line mode for generating these predicted item-specific embeddings of collaborative type prior to receiving an indication of a request for content recommendation from a user device.

In a first broad aspect of the present technology, there is provided a method of training a Machine Learning Algorithm (MLA) to generate a predicted collaborative embedding for a digital item. The digital item is a potential recommendation item of a content recommendation system. The content recommendation system is configured to recommend items to users of the content recommendation system. The content recommendation system is hosted by a server. The method is executable by the server. The method comprises generating, by the server, a training set for a training item. The generating includes generating, by the server employing an other MLA, a target collaborative embedding for the training item based on previous user interactions between the users of the content recommendation system and the training item. The previous user interactions between the users and the training item is sufficient for generating the target collaborative embedding. The training set comprises the target collaborative embedding and the training item. The training item is a training input for a given training iteration and the target collaborative embedding is a training target for the given training iteration. The method comprises, during the given training iteration, inputting, by the server, the training item into the MLA. The MLA is configured to generate a predicted collaborative embedding for the training item. The method comprises, during the given training iteration, determining, by the server, a penalty score for the given training iteration by comparing the predicted collaborative embedding generated by the MLA and the target collaborative embedding generated by the other MLA. The penalty score is indicative of a similarity between the predicted collaborative embedding and the target collaborative embedding of the training item. The method comprises, during the given training iteration, adjusting, by the server, the MLA using the penalty score so as to increase the similarity between the predicted collaborative embedding and the target collaborative embedding of the training item.

In some embodiments of the method, the inputting the training item comprises inputting, by the server, raw textual data of the training item.

In some embodiments of the method, the method further comprises determining, by the server, the raw textual data based on content of the training item.

In some embodiments of the method, the other MLA is a Singular Value Decomposition (SVD) based MLA.

In some embodiments of the method, the method further comprises acquiring, by the server, an indication of a request for content recommendation from a given user of the content recommendation system. The method further comprises determining, by the server, a plurality of potential recommendation items to be provided to the given user. The plurality of potential recommendation items includes a set of items associated with the previous user interactions between the users and the respective items from the set of items, and at least one other item, where the at least one other item includes the digital item. The method further comprises acquiring, by the server, a collaborative embedding for a given from the set of items. The collaborative embedding has been determined by the other MLA based on the previous user interactions between the users and the given item from the set of items. The previous user interactions between the users and the given item have been sufficient for determining the collaborative embedding for the given item by the other MLA. The method further comprises acquiring, by the server, a predicted collaborative embedding for the digital item. The method further comprises acquiring, by the server, a user collaborative embedding for the given user. The user collaborative embedding has been determined by the other MLA based on the previous user interactions between the user and the items from the set of items. The method further comprises acquiring, by the server, an other user embedding for the given user. The other user embedding has been determined by a second other MLA based on the predicted collaborative embedding for the digital item and user interactions between the given user and items of the recommendation system. The method further comprises generating, by the server, a parameter for the digital item as a product of (i) the predicted collaborative embedding of the digital item and (ii) the other user embedding. The parameter is an input into a third MLA configured to rank the plurality of potential recommendation items. The method further comprises generating, by the server, an other parameter for the given item from the set of items as a product of (i) the respective collaborative embedding, and (ii) the user collaborative embedding. The other parameter is an input into the third MLA configured to rank the plurality of potential recommendations items.

In some embodiments of the method, the other MLA has been unable to determine a given collaborative embedding for the digital items due to a limited amount of user interactions between the digital item and the users.

In some embodiments of the method, the collaborative embedding has been determined by the other MLA in an off-line mode, prior to receipt of the indication of the request for content recommendation.

In some embodiments of the method, the third MLA is a decision-tree based MLA.

In some embodiments of the method, the method further comprises acquiring, by the server, an other predicted collaborative embedding for a given item for the set of items, where the other predicted collaborative embedding has been generated by the MLA based on content data associated with the given item. The method further comprises generating, by the server, a second other parameter for the given item as a product of (i) the other predicted collaborative embedding of the given item and (ii) the other user embedding, the other parameter being an input into the third MLA configured to rank the plurality of potential recommendation items.

In some embodiments of the method, the other MLA is trained on a plurality of training sets.

In some embodiments of the method, the training item is used in a second plurality of training sets, and the plurality of training sets is larger than the second plurality of training sets.

In a second broad aspect of the present technology, there is provided a server for training a Machine Learning Algorithm (MLA) to generate a predicted collaborative embedding for an digital item. The digital item is a potential recommendation item of a content recommendation system. The content recommendation system is configured to recommend items to users of the content recommendation system. The content recommendation system is hosted by the server. The server is configured to generate a training set for a training item. The server is further configured to generate, by employing an other MLA, a target collaborative embedding for the training item based on previous user interactions between the users of the content recommendation system and the training item. The previous user interactions between the users and the training item are sufficient for generating the target collaborative embedding. The training set comprises the target collaborative embedding and the training item. The training item is a training input for a given training iteration and the target collaborative embedding is a training target for the given training iteration. The server is configured to, during the given training iteration, input the training item into the MLA and the MLA is configured to generate a predicted collaborative embedding for the training item. The server is configured to, during the given training iteration, determine a penalty score for the given training iteration by comparing the predicted collaborative embedding generated by the MLA and the target collaborative embedding generated by the other MLA. The penalty score is indicative of a similarity between the predicted collaborative embedding and the target collaborative embedding of the training item. The server is configured to, during the given training iteration, adjust the MLA using the penalty score so as to increase the similarity between the predicted collaborative embedding and the target collaborative embedding of the training item.

In some embodiments of the server, the input the training item comprises the server configured to input raw textual data of the training item.

In some embodiments of the server, the server is further configured to determine the raw textual data based on content of the training item.

In some embodiments of the server, the other MLA is a Singular Value Decomposition (SVD) based MLA.

In some embodiments of the server, the server is further configured to acquire an indication of a request for content recommendation from a given user of the content recommendation system. The server is further configured to determine a plurality of potential recommendation items to be provided to the given user. The plurality of potential recommendation items includes a set of items associated with previous user interactions between the users and the respective items from the set of items, and at least one other item, where the at least one other item includes the digital item. The server is further configured to acquire a collaborative embedding for a given item from the set of items. The collaborative embedding has been determined by the other MLA based on the previous user interactions between the users and the given item from the set of items. The previous user interactions between the users and the given item have been sufficient for determining the collaborative embedding for the given item by the other MLA. The server is further configured to acquire a predicted collaborative embedding for the digital item. The server is further configured to acquire a user collaborative embedding for the given user, where the user collaborative embedding has been determined by the other MLA based on the previous user interactions between the user and the items from the set of items. The server is further configured to acquire an other user embedding for the given user, where the other user embedding has been determined by a second other MLA based on the predicted collaborative embedding for the digital item and user interactions between the given user and items of the recommendation system. The server is further configured to generate a parameter for the digital item as a product of (i) the predicted collaborative embedding of the digital item and (ii) the other user embedding, where the parameter is an input into a third MLA configured to rank the plurality of potential recommendation items/ The server is further configured to generate an other parameter for the given item from the set of items as a product of (i) the respective collaborative embedding, and (ii) the user collaborative embedding, where the other parameter is an input into the third MLA configured to rank the plurality of potential recommendations items.

In some embodiments of the server, the other MLA has been unable to determine a given collaborative embedding for the digital items due to a limited amount of user interactions between the digital item and the users.

In some embodiments of the server, the collaborative embedding has been determined by the other MLA in an off-line mode, prior to receipt of the indication of the request for content recommendation.

In some embodiments of the server, the third MLA is a decision-tree based MLA.

In some embodiments of the server, the server is further configured to acquire an other predicted collaborative embedding for a given item for the set of items, the other predicted collaborative embedding having been generated by the MLA based on content data associated with the given item, and generate a second other parameter for the given item as a product of (i) the other predicted collaborative embedding of the given item and (ii) the other user embedding, where the second other parameter is an input into the third MLA configured to rank the plurality of potential recommendation items.

In some embodiments of the server, the other MLA is trained on a plurality of training sets.

In some embodiments of the server, the training item is used in a second plurality of training sets, and wherein the plurality of training sets is larger than the second plurality of training sets.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a diagram of a system implemented in accordance with non-limiting embodiments of the present technology.

FIG. 2 depicts a representation of data stored by a database of the system of FIG. 1, in accordance with non-limiting embodiments of the present technology.

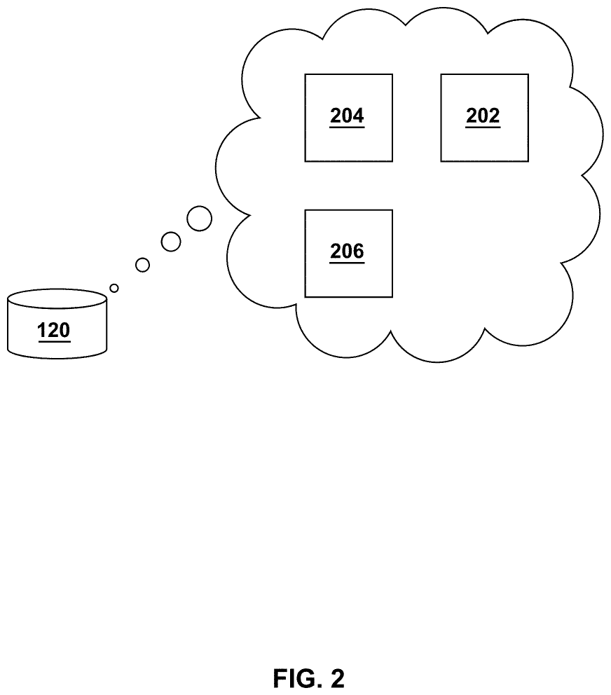

FIG. 3 depicts a representation of how a given Singular Value Decomposition (SVD) based Machine Learning Algorithm (MLA) is implemented by a server of the system of FIG. 1, in accordance with non-limiting embodiments of the present technology.

FIG. 4 depicts a representation of how a training iteration and an in-use iteration of a Transfer Learning (TL) based MLA are executed by the server of FIG. 1, in accordance with non-limiting embodiments of the present technology.

FIG. 5 depicts a representation of how the database is accessed by the server of in FIG. 1 response to a request for content recommendation, in accordance with non-limiting embodiments of the present technology.

FIG. 6 depicts a representation of how the server of FIG. 1 is configured to generate parameters for respective in-use item, in accordance with non-limiting embodiments of the present technology.

FIG. 7 depicts an in-use phase of a given decision-tree based MLA for ranking in-use items, in accordance with non-limiting embodiments of the present technology.

FIG. 8 depicts a screen shot of a recommendation interface implemented in accordance with non-limiting embodiment of the present technology.

FIG. 9 depicts a block diagram of a method of training the TL based MLA of FIG. 4, the method executable by the server of FIG. 1, in accordance with embodiments of the present technology.

FIG. 10 depicts a screen shot of an other recommendation interface implemented in accordance with non-limiting embodiment of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether such computer or processor is explicitly shown.

The functions of the various elements shown in the figures, including any functional block labeled as a “processor” or a “graphics processing unit”, may be provided using the dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

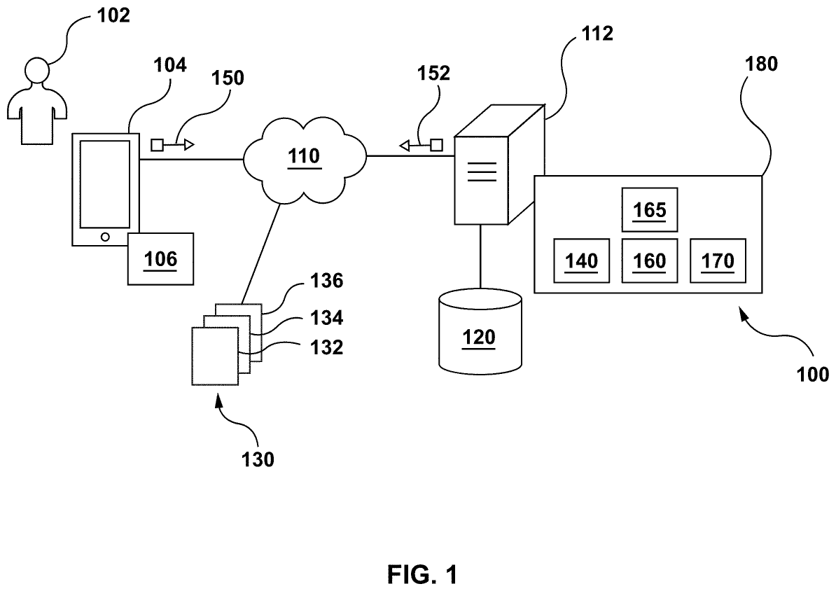

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case, they have been presented in this manner as an aid to understanding. As persons skilled in the art would understand, various implementations of the present technology may be of a greater complexity.

Generally speaking, the system 100 is configured to provide digital content recommendations to users of the system 100. For example, a user 102 (a given one of a plurality of users of the system 100) may be a subscriber to a recommendation service provided by the system 100. However, the subscription does not need to be explicit or paid for. For example, the user 102 can become a subscriber by virtue of downloading a recommendation application from the system 100, by registering and provisioning a log-in/password combination, by registering and provisioning user preferences and the like. As such, any system variation configured to generate content recommendations for the given user can be adapted to execute embodiments of the present technology, once teachings presented herein are appreciated. Furthermore, the system 100 will be described using an example of the system 100 being a recommendation system (therefore, the system 100 can be referred to herein below as a “recommendation system 100” or a “prediction system 100” or a “training system 100”). However, embodiments of the present technology can be equally applied to other types of the system 100, as will be described in greater detail herein below.

### Electronic Device

The system 100 comprises an electronic device 104, the electronic device 104 being associated with the user 102. As such, the electronic device 104 can sometimes be referred to as a “client device”, “end user device” or “client electronic device”. It should be noted that the fact that the electronic device 104 is associated with the user 102 does not need to suggest or imply any mode of operation—such as a need to log in, a need to be registered, or the like.

It should be noted that, although only the user 102 associated with the electronic device 104 is depicted in FIG. 1, it is contemplated that the user 102 associated with the electronic device 104 is a given user from the plurality of users of the system 100, and where each one of the plurality of users (not depicted) can be associated with a respective electronic device (not depicted).

The implementation of the electronic device 104 is not particularly limited, but as an example, the electronic device 104 may be implemented as a personal computer (desktops, laptops, netbooks, etc.), a wireless communication device (such as a smartphone, a cell phone, a tablet and the like), as well as network equipment (such as routers, switches, and gateways). The electronic device 104 comprises hardware and/or software and/or firmware (or a combination thereof), as is known in the art, to execute a recommendation application 106. Generally speaking, the purpose of the recommendation application 106 is to enable the user 102 to receive (or otherwise access) digital content recommendations provided by the system 100, as will be described in greater detail herein below.

How the recommendation application 106 is implemented is not particularly limited. One example of the recommendation application 106 may include the user 102 accessing a web site associated with the recommendation service to access the recommendation application 106. For example, the recommendation application 106 may be accessed by typing in (or otherwise copy-pasting or selecting a link) an URL associated with the recommendation service. Alternatively, the recommendation application 106 may be an application downloaded from a so-called “app store”, such as APPSTORE™ or GOOGLEPLAY™ and installed/executed on the electronic device 104. It should be expressly understood that the recommendation application 106 may be accessed using any other suitable means. In yet additional embodiments, the recommendation application 106 functionality may be incorporated into another application, such as a browser application (not depicted) or the like. For example, the recommendation application 106 may be executed as part of the browser application, for example, when the user 102 starts the browser application, the functionality of the recommendation application 106 may be executed.

Generally speaking, the recommendation application 106 comprises a recommendation interface (not depicted) being displayed on a screen of the electronic device 104.

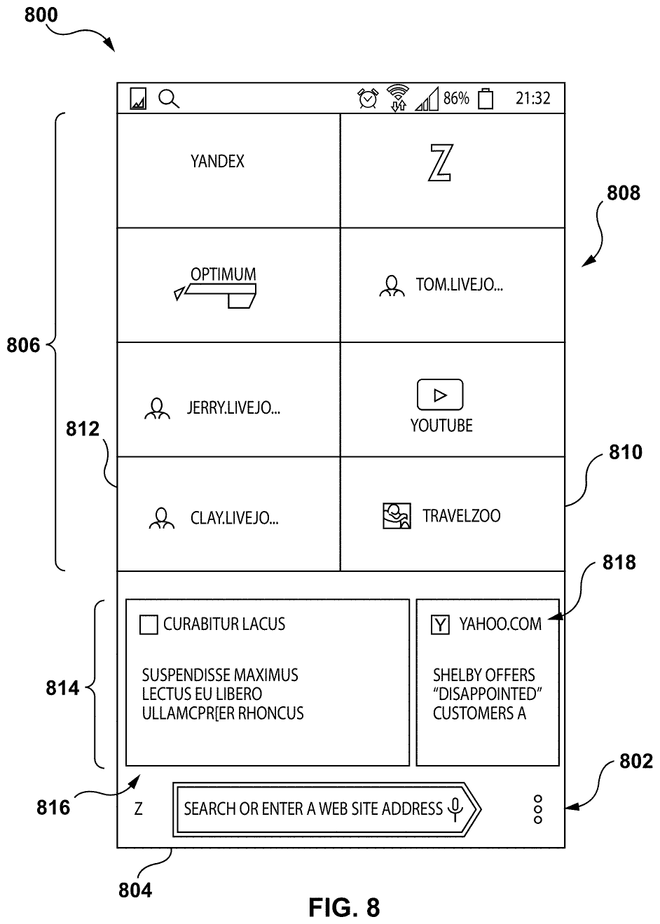

With reference to FIG. 8, there is depicted a screen shot 800 of the recommendation interface implemented in accordance with a non-limiting embodiment of the present technology (the example of the recommendation interface being depicted as displayed on the screen of the electronic device 104 being implemented as a smart phone).

In some embodiments of the present technology the recommendation interface may be presented/displayed when the user 102 of the electronic device 104 actuates (i.e. executes, run, background-run or the like) the recommendation application 106. Alternatively, the recommendation interface may be presented/displayed when the user 102 opens a new browser window and/or activates a new tab in the browser application. For example, in some embodiments of the present technology, the recommendation interface may act as a “home screen” in the browser application.

The recommendation interface includes a search interface 802. The search interface 802 includes a search query interface 804. The search query interface 804 may be implemented as an “omnibox” which allows entry of a search query for executing a search or a given network address (such as a Universal Remote Locator) for identifying a given network resource (such as a web site) to be accessed. However, the search query interface 804 may be configured to receive one or both of: entry of the search query for executing the search or a given network address (such as a Universal Remote Locator) for identifying a given network resource (such as a web site) to be accessed.

The recommendation interface further includes a links interface 806. The links interface 806 includes a plurality of tiles 808—of which eight are depicted in FIG. 8—only two of which are numbered in FIG. 8—a first tile 810 and a second tile 812.

Using the example of the first tile 810 and the second tile 812—each of the plurality of tiles 808 includes (or acts as) a link to either (i) a web site marked as “favorite” or otherwise marked by the user 102, (ii) a previously visited web site or (iii) the like. The plurality of tiles 808, in the depicted embodiment, is visually presented to the user 102 as square buttons with a logo and/or a name of the resource depicted therein, the logo and the name for enabling the user 102 to identify which resource the particular one of the plurality of tiles (not separately numbered) is linked to. However, it should be expressly understood that the visual representation of some or all of the plurality of tiles 208 may be different. As such, some or all of the plurality of tiles 208 may be implemented as differently shaped buttons, as hyperlinks presented in a list or the like.

As an example, the first tile 810 contains a link to a TRAVELZOO™ web site and the second tile 812 contains a link to a personal live journal web site. Needless to say, the number and content of the individual ones of the plurality of tiles 808 is not particularly limited.

For example, the number of the tiles within the plurality of tiles 808 may be pre-selected by the provider of the recommendation application 106. In some embodiments of the present technology, the number of tiles within the plurality of tiles 808 may be pre-selected based on the size and/or resolution of the screen of the electronic device 104 executing the recommendation application 106. For example, a first number of tiles may be pre-selected for the electronic device 104 executed as a smartphone, a second number of tiles may be pre-selected for the electronic device 104 executed as a tablet, and a third number of tiles may be pre-selected for the electronic device 104 executed as a laptop or desktop computer.

The recommendation interface further includes a recommended digital content set 814. The recommended digital content set 814 includes one or more recommended digital documents, such as a first recommended digital document 816 and a second recommended digital document 818 (the second recommended digital document 818 only partially visible in FIG. 8). Naturally, the recommended digital content set 814 may have more recommended digital documents. In the embodiment depicted in FIG. 8 and in those embodiments where more than one recommended digital documents are present, the user 102 may scroll through the recommended digital content set 814. The scrolling may be achieved by any suitable means. For example, the user 102 can scroll the content of the recommended digital content set 814 by means of actuating a mouse device (not depicted), a key board key (not depicted) or interacting with a touch sensitive screen (not depicted) of or associated with the electronic device 104.

Example provided in FIG. 8 is just one possible implementation of the recommendation interface. Another example of the implementation of the recommendation interface, as well as an explanation of how the user 102 may interact with the recommendation interface 108 is disclosed in a co-owned Russian Patent Application entitled “A COMPUTER-IMPLEMENTED METHOD OF GENERATING A CONTENT RECOMMENDATION INTERFACE”, filed on May 12, 2016 and bearing an application number 2016118519; content of which is incorporated by reference herein in its entirety.

Returning to the description of FIG. 1, the electronic device 104 is configured to generate a request 150 for digital content recommendation. The request 150 may be generated in response to the user 102 providing an explicit indication of the user desire to receive a digital content recommendation. For example, the recommendation interface 108 may provide a button (or another actuatable element) to enable the user 102 to indicate her/his desire to receive a new or an updated digital content recommendation.

As an example, the recommendation interface may provide an actuatable button that reads “Request content recommendation”. Within these embodiments, the request 150 for digital content recommendation can be thought of as “an explicit request” in a sense of the user 102 expressly providing a request for the digital content recommendation.

In other embodiments, the request 150 for digital content recommendation may be generated in response to the user 102 providing an implicit indication of the user desire to receive the digital content recommendation. In some embodiments of the present technology, the request 150 for digital content recommendation may be generated in response to the user 102 starting the recommendation application 106.

Alternatively, in those embodiments of the present technology where the recommendation application 106 is implemented as a browser (for example, a GOOGLE™ browser, a YANDEX™ browser, a YAHOO!™ browser or any other proprietary or commercially available browser application), the request 150 for digital content recommendation may be generated in response to the user 102 opening the browser application and may be generated, for example, without the user 102 executing any additional actions other than activating the browser application.

Optionally, the request 150 for digital content recommendation may be generated in response to the user 102 opening a new tab of the already-opened browser application and may be generated, for example, without the user 102 executing any additional actions other than activating the new browser tab.

Therefore, it is contemplated that in some embodiments of the present technology, the request 150 for digital content recommendation may be generated even without the user 102 knowing that the user 102 may be interested in obtaining a digital content recommendation.

Optionally, the request 150 for digital content recommendation may be generated in response to the user 102 selecting a particular element of the browser application and may be generated, for example, without the user 102 executing any additional actions other than selecting/activating the particular element of the browser application.

Examples of the particular element of the browser application include but are not limited to:
an address line of the browser application bar;
a search bar of the browser application and/or a search bar of a search engine web site accessed in the browser application;
an omnibox (combined address and search bar of the browser application);
a favorites or recently visited network resources pane; and
any other pre-determined area of the browser application interface or a network resource displayed in the browser application.

How the content for the recommended digital content set 214 is generated and provided to the electronic device 104 will be described in greater detail herein further below.

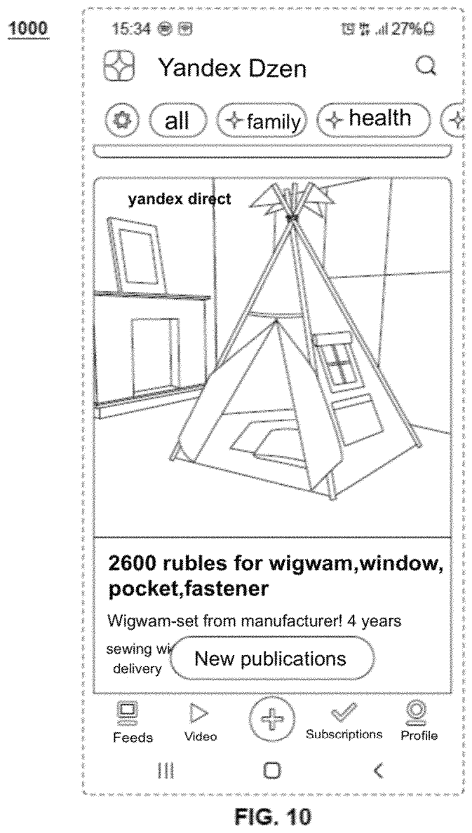

It should be noted that the recommended digital content set 214 may be updated continuously, or in other words, additional digital items may be transmitted to the electronic device 104 such that the user 102 is provided with an “infinite” content recommendation feed. For example, with reference to FIG. 10, there is depicted a screen shot 1000 of the recommendation interface implemented in accordance with an other non-limiting embodiment of the present technology (the example of the recommendation interface being depicted as displayed on the screen of the electronic device 104 being implemented as a smart phone). It can be said that the recommendation interface of FIG. 10 may be configured to provide a continuously-updated feed of recommendation items to the user 102.

### Communication Network

The electronic device 104 is communicatively coupled to a communication network 110 for accessing a recommendation server 112 (or simply the server 112).

In some non-limiting embodiments of the present technology, the communication network 110 may be implemented as the Internet. In other embodiments of the present technology, the communication network 110 can be implemented differently, such as any wide-area communication network, local-area communication network, a private communication network and the like.

How a communication link (not separately numbered) between the electronic device 104 and the communication network 110 is implemented will depend inter alia on how the electronic device 104 is implemented. Merely as an example and not as a limitation, in those embodiments of the present technology where the electronic device 104 is implemented as a wireless communication device (such as a smartphone), the communication link can be implemented as a wireless communication link (such as but not limited to, a 3G communication network link, a 4G communication network link, Wireless Fidelity, or WiFi® for short, Bluetooth® and the like). In those examples where the electronic device 104 is implemented as a notebook computer, the communication link can be either wireless (such as Wireless Fidelity, or WiFi® for short, Bluetooth® or the like) or wired (such as an Ethernet based connection).

### Plurality of Network Resources

Also coupled to the communication network 110 is a plurality of network resources 130 that includes a first network resource 132, a second network resource 134 and a plurality of additional network resources 136. The first network resource 132, the second network resource 134 and the plurality of additional network resources 136 are all network resources accessible by the electronic device 104 (as well as other electronic devices potentially present in the system 100) via the communication network 110. Respective digital content of the first network resource 132, the second network resource 134 and the plurality of additional network resources 136 is not particularly limited.

It is contemplated that any given one of the first network resource 132, the second network resource 134 and the plurality of additional network resources 136 may host (or in other words, host) digital documents having potentially different types of digital content. As it will become apparent from the description herein further below, the plurality of network resources 136 may be hosting at least some of the potentially recommendable content items of the system 100.

For example, digital content of digital documents may include but is not limited to: audio digital content for streaming or downloading, video digital content for streaming or downloading, news, blogs, information about various government institutions, information about points of interest, thematically clustered content (such as content relevant to those interested in kick-boxing), other multi-media digital content, and the like.

In another example, digital content of the digital documents hosted by the first network resource 132, the second network resource 134 and the plurality of additional network resources 136 may be text-based. Text-based digital content may include but is not limited to: news, articles, blogs, information about various government institutions, information about points of interest, thematically clustered digital content (such as digital content relevant to those interested in kick-boxing), and the like. It is contemplated that in at least some embodiments of the present technology, “raw” textual data from text-based content items may be extracted by a server 112 and stored in a database 112 for further processing.

It should be noted, however, that “text-based” digital content does not intend to mean that the given digital document only contains text to the exclusion of other type of multi-media elements. On the contrary, the given text-based digital document may include text elements, as well as potentially other type of multi-media elements. For instance, a given text-based digital document that is an article may include text, as well as photos. As another example, a given text-based digital document that is a blog may include text, as well as embedded video elements.

It should be noted digital content items from a given network resource may be published by a publishing entity, or simply a “publisher”. Generally speaking, a given publisher generates digital content and publishes it such that its digital content becomes available on a given network resource. It should be noted that a given publisher usually generates and publishes digital content having a common type and/or common topic. For example, a given publisher that usually publishes digital content related to sport news, is likely to publish new digital content also related to sport news.

Generally speaking, digital content items are potentially “discoverable” by the electronic device 104 via various means. For example, the user 102 of the electronic device 104 may use a browser application (not depicted) and enter a Universal Resource Locator (URL) associated with the given one of the first network resource 132, the second network resource 134 and the plurality of additional network resources 136. In another example, the user 102 of the electronic device 104 may execute a search using a search engine (not depicted) to discover digital content of one or more of the first network resource 132, the second network resource 134 and the plurality of additional network resources 136. As has been mentioned above, these are useful when the user 102 knows apriori which digital content the user 102 is interested in.

In at least some embodiments of the present technology, it is contemplated that the user 102 may appreciate one or more digital content items potentially recommendable by a recommendation system 180 hosted by the server 112. How the server 112 and the recommendation system 180 can be implemented in some embodiments of the present technology will now be described.

### Recommendation Server

The server 112 may be implemented as a conventional computer server. In an example of an embodiment of the present technology, the server 112 may be implemented as a Dell™ PowerEdge™ Server running the Microsoft™ Windows Server™ operating system. Needless to say, the server 112 may be implemented in any other suitable hardware, software, and/or firmware, or a combination thereof. In the depicted non-limiting embodiments of the present technology, the server 112 is a single server. In alternative non-limiting embodiments of the present technology, the functionality of the server 112 may be distributed and may be implemented via multiple servers.

Generally speaking, the server 112 is configured to (i) receive the request 150 for digital content recommendation from the electronic device 104 and (ii) responsive to the request 150, generate a recommended digital content message 152 to be transmitted to the electronic device 104.

It is contemplated that at least some of digital content in the recommended digital content message 152 may be specifically generated or otherwise customized for the user 102 associated with the electronic device 104. As part of digital content in the recommended digital content message 152, the server 112 may be configured to provide inter alia information indicative of the recommended digital content set 814 to the electronic device 104 for display to the user 102 (on the recommendation interface of the recommendation application 106).

It should be understood that the recommended digital content set 814 provided to the user 102 by the server 112 may comprise given digital content that is available at one of the plurality of network resources 130, without the user 102 knowing the given digital content apriori. How the recommended digital content set 814 is generated by the server 112 will be described in greater detail further below.

As previously alluded to, the recommendation server 112 is configured to execute a plurality of the computer-implemented procedures that together are referred to herein as the “recommendation system” 180. In the context of the present technology, the server 112 providing recommendation services via the recommendation system 180 is configured to employ one or more Machine Learning Algorithms (MLAs) for supporting a variety of search engine services. Notably, the recommendation system 180 one or more MLAs can be used by the server 112 in order to generate the recommended digital content set 814.

Generally speaking, MLAs are configured to “learn” from training samples and make predictions on new (unseen) data. MLAs are usually used to first build a model based on training inputs of data in order to then make data-driven predictions or decisions expressed as outputs, rather than following static computer-readable instructions. For that resource, MLAs can be used as estimation models, ranking models, classification models and the like.

It should be understood that different types of the MLAs having different architectures and/or topologies may be used for implementing the MLA in some non-limiting embodiments of the present technology. Nevertheless, the implementation of a given MLA by the server 112 can be broadly categorized into two phases—a training phase and an in-use phase. First, the given MLA is trained in the training phase. Then, once the given MLA knows what data to expect as inputs and what data to provide as outputs, the MLA is run using in-use data in the in-use phase.

In at least some embodiments of the present technology, the server 112 may be configured to execute a decision-tree based MLA 140. Broadly speaking, a given decision-tree based MLA is a machine learning model having one or more “decision trees” that are used (i) to go from observations about an object (represented in the branches) to conclusions about the object's target value (represented in the leaves). In one non-limiting implementation of the present technology, the decision-tree based MLA 140 can be implemented in accordance with the CatBoost framework.

How the decision-tree based MLA 140 can be trained in accordance with at least some embodiments of the present technology is disclosed in a US Patent Publication no. 2019/0164084, entitled “METHOD OF AND SYSTEM FOR GENERATING PREDICTION QUALITY PARAMETER FOR A PREDICATION MODEL EXECUTED IN A MAHCINE LEARNING ALGORITHM”, published on May 30, 2019, content of which is incorporated by reference herein in its entirety. Additional information regarding the CatBoost library, its implementation, and gradient boosting algorithms is available at https://catboost.ai.

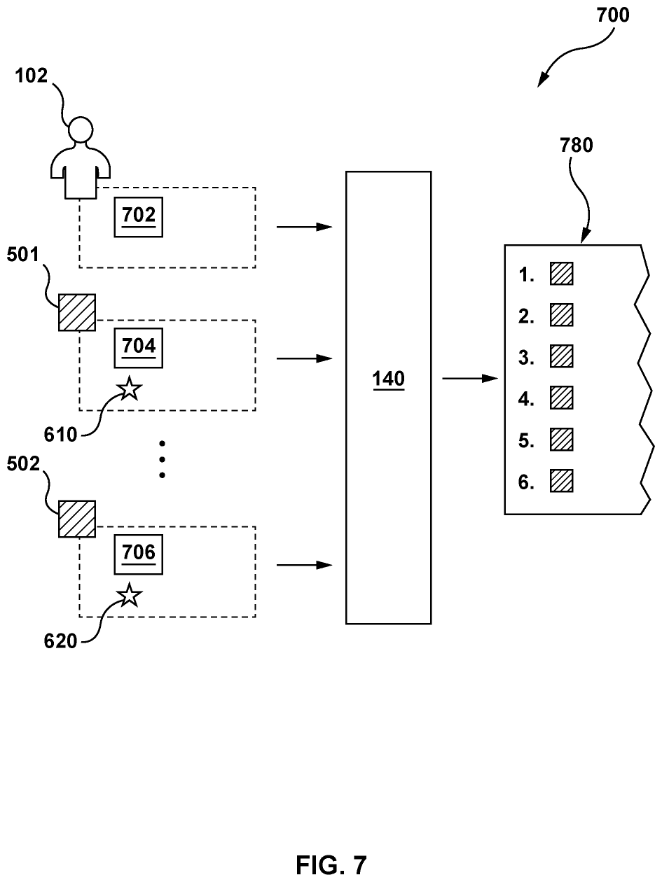

In at least some embodiments of the present technology, it is contemplated that the server 112 may be configured to use the decision-tree based MLA 140 in order to predict a ranked list of at least some potentially recommendable content items. As it will be described herein further below with reference to FIG. 7, the server 102 may be configured to provide the decision-tree based MLA 140 with input data including (i) data associated with the user 102, and (ii) data associated with a plurality of digital content items (including items 501, and 502), and the decision-tree based MLA 140 is configured to output a ranked list of content items 780.

Returning to the description of FIG. 1, in at least some embodiments of the present technology, the server 112 may be configured to execute one or more Singular Value Decomposition (SVD) based MLAs, such as SVD based MLAs 160 and 165. Broadly speaking, a given SVD based MLA is a machine learning model used to decompose “matrix-structure data” into its “constituent elements”. For example, SVD based models are used as machine learning tools for data reduction purposes, in least squares linear regression, image compression, and others. In some embodiments of the present technology, the SVD based MLA 160 and the SVD based MLA 165 may be implemented as respective Neural Networks (NNs) trained to decompose matrix-structured data into one or more vectors/embeddings.

It should be noted that the manner in which a given SVD based MLA (such as SVD based MLAs 160 and 165, for example) can be implemented by the server 112 in some embodiments of the present technology is generally described in US patent publication number 2018/0075137, entitled “METHOD AND APPARATUS FOR TRAINING A MACHINE LEARNING ALGORITHM (MLA) FOR GENERATING A CONTENT RECOMMENDATION IN A RECOMMENDATION SYSTEM AND METHOD AND APPARATUS FOR GENERATING THE RECOMMENDED CONTENT USING THE MLA, published on May 15 2018; the content of which is incorporated herein by reference in its entirety and, therefore, will not be discussed in greater detail herein below. However, it should be noted that, although both are configured to receive matrix-structured data as input, it is contemplated that the SVD based MLA 160 may receive user-item interaction data of a first type as input, while the SVD based MLA 165 may receive user-item interaction data of a second type as input. In other embodiments, the SVD based MLA 165 may receive content-based data and user-item interaction based data as input.

In at least some embodiments of the present technology, it is contemplated that the server 112 may be configured to use the SVD based MLA 160 and the SVD based MLA 165 in order to generate different types of “embeddings”. Broadly speaking, an embedding is a relatively low-dimensional space into which you can translate high-dimensional vectors. Embeddings make it easier to do machine learning on large inputs like sparse vectors representing words, for example. Ideally, an embedding captures some of the semantics of the input by placing semantically similar inputs close together in the embedding space. It is also contemplated that embeddings can be learned and reused across models.

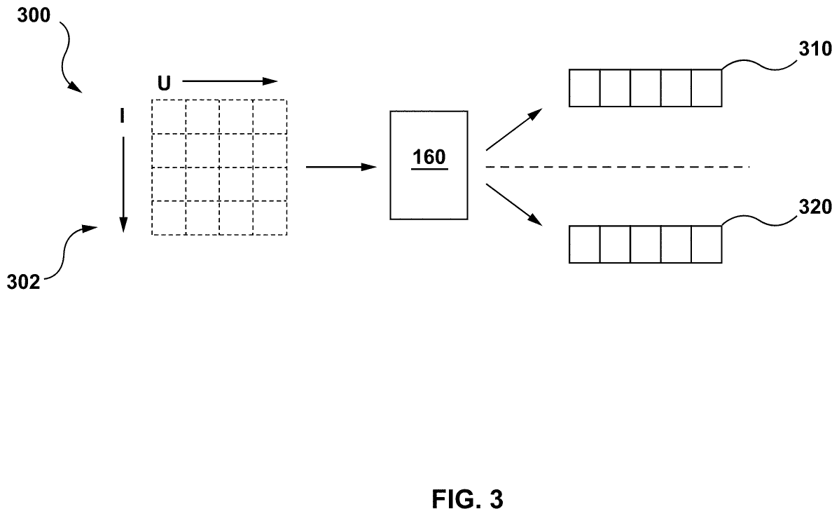

As it will be described in greater details herein further below, with reference to FIG. 3, the server 112 may be configured to use the SVD based MLA 160 to generate two types of embeddings based on a user-item interaction matrix 302. For example, the SVD based MLA 160 may be configured to generate a collaborative-type item embedding 310 for a given content item and a collaborative-type user embedding for a given user—that is, an “item-specific embedding” of a collaborative type, and a “user-specific” embedding of a collaborative type.

It should be noted that the SVD based MLA 165 may be used to generate other types of embeddings. As it will be described in greater details below, the SVD based MLA 165 may be configured to generate a “user-specific embedding” that is different from the user-specific embedding generated by the SVD based MLA 160. As it will become apparent from the description herein further below, the SVD based MLA 165 may be configured to receive as input a user-item interaction data matrix (with missing user-item interactions being estimated) and a predicted item embedding (predicted based on content) in order to, in a sense, “reconstruct” a user-specific embedding to be used in combination with the predicted item embedding when generating ranking features.

It should be noted that in at least some embodiments of the present technology, the server 112 may be configured to use the SVD type MLA 160 for performing what is called Collaborative Filtering (CF) of recommendation content. Broadly speaking, CF based methods leverage historical interactions between users and digital content items for filtering out less desirable content when making recommendations to users. However, CF based methods typically suffer from limited performance when user-item interactions are very sparse, which is common for scenarios such as online shopping or any other recommendation platform having an very large potentially recommendable item set. As it will become apparent from the description herein further below, the developers of the present technology have devised methods and systems for increasing the performance of the recommendation system 180 generally, and specifically, in those cases where user-item interactions are very sparse.

Returning to the description of FIG. 1, in at least some embodiments of the present technology, the server 112 may be configured to execute a Transfer Learning (TL) based MLA 170. Broadly speaking, TL is a branch of ML that focuses on storing knowledge gained while solving one problem and applying it to a different, but related problem. Developers of the present technology have realized that TL is particularly useful (i) when there is insufficient data for a new domain to be handled by an MLA and (ii) where there is a large pre-existing data pool that can be, in a sense, “transferred” to that problem.

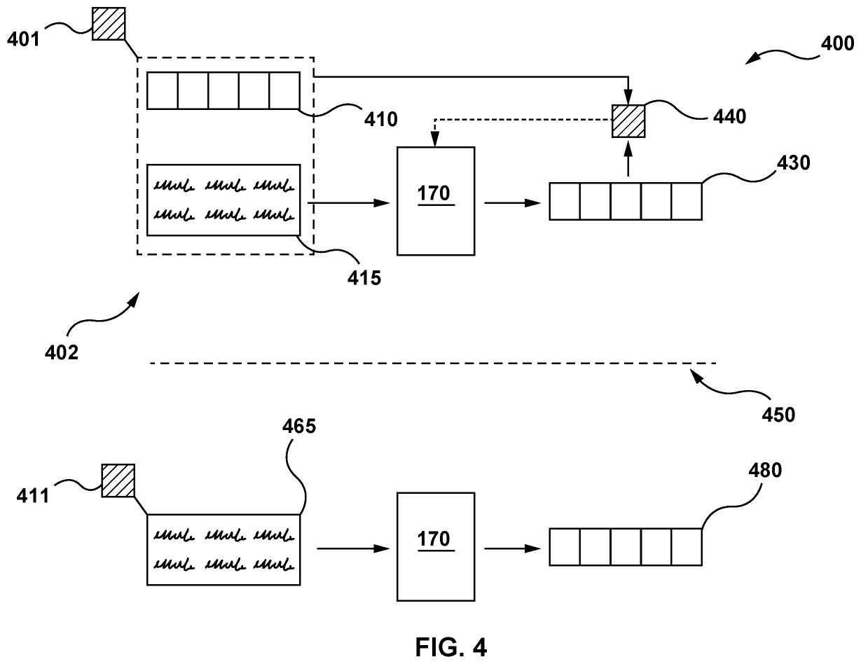

As it will become apparent from the description herein further below, with reference to FIG. 4, the server 112 may be configured to train the TL based MLA 170 to predict a given “predicted collaborative item embedding”—that is, a predicted item-specific embedding of a collaborative type—for a given item based on information about the content of the given item. In at least some embodiments of the present technology, it is contemplated that the server 112 may be configured to use raw textual data representative of content of a given item in order to generate a respective predicted item-specific embedding of a collaborative type, even if the recommendation system 180 has insufficient user-item interaction history for generating a respective item-specific embedding of a collaborative type via the SVD based MLA 160.

### Database

The server 112 is communicatively coupled to a database 120. The database 120 is depicted as a separate entity from the server 112. However, it is contemplated that the database 120 may be implemented integrally with the server 112, without departing from the scope of the present technology. Alternatively, functionalities of the database 120 as described below may be distributed between more than one physical devices.

Generally speaking, the database 120 is configured to store data generated, retrieved and/or processed by the server 112 for temporary and/or permanent storage thereof. For example, the database 120 may be configured to store inter alia data for training and using one or more MLAs of the recommendation system 180.

The database 120 stored information associated with respective items of the recommendation system 180, hereinafter referred to as item data 202. The item data 202 includes information about respective digital content discovered and catalogued by the server 112. For example, the item data 202 may include the digital content of respective digital content items that are potentially recommendable by the recommendation system 180.

The nature of digital content that is potentially recommendable by the server 112 is not particularly limited. Some examples of digital content that is potentially recommendable by the server 112 include, but are not limited to, digital documents such as:
a news article;
a publication;
a web page;
a post on a social media web site;
a new application to be downloaded from an app store;
a new song (music track) to play/download from a given network resource;
an audiobook to play/download from a given network resource;
a podcast to play/download from a given network resource;
a new movie (video clip) to play/download from a given network resource;
a product to be bought from a given network resource; and
a new digital document uploaded for viewing on a social media web site (such as a new photo uploaded to an INSTRAGRAM™ or FACEBOOK™ account).

In some non-limiting embodiments of the present technology, the item data 202 may comprise raw textual data from respective digital content items. This means that the server 112 may be configured to parse a given digital content item, extract (raw) textual content from that item and store it in association with that item as part of the item data 202.

In other non-limiting embodiments, the item data 202 may comprise information about one or more item features associated with respective digital content items. For example, the database 120 may store data associated with respective items indicative of, but not limited to:
popularity of a given item;
click-through-rate for the given item;
time-per-click associated with the given item;
other statistical data associated with the given item; and
others.

As it will become apparent from the description herein further below, the server 112 may be configured to store (as part of the item data 202) in the database 120 one or more item-specific embeddings of one or more types associated with respective digital content items. As mentioned above, the server 112 may be configured to use the one or more MLAs of the recommendation system 180 for generating item-specific embeddings (including the predicted ones) and may then store them in the database 120 for further processing. For example, the server 112 may be configured to generate and store item-specific embeddings in an off-line mode of the recommendation system 180, and then retrieve them for further processing during an on-line mode of the recommendation system 180. It is contemplated that an on-line mode may correspond to a moment in time (i) after receipt of the request 150 by the server 112, and/or (ii) during a “high-demand” period when the computational resources of the server 112 are limited due to user requests. It is contemplated that an off-line mode may correspond to a moment in time (i) prior to the receipt of the request 150 by the server 112, and/or (ii) during a “low-demand” period when the computational resources of the server 112 are not limited by user requests.

In additional embodiments of the present technology, the database 120 may be populated with additional information about the plurality of users of the recommendation service, hereinafter referred to as user data 206. For example, the server 112 may be configured to collect and store in the database 120 user-profile data associated with respective users of the recommendation system 180 such as, but not limited to: name, age, gender, user-selected types of digital content that (s)he desires, and the like. Other information about the plurality of users of the recommendation service may also be stored in the user database 120 as part of the user data 206, without departing from the scope of the present technology.

As it will become apparent from the description herein further below, the server 112 may be configured to store (as part of the user data 206) in the database 120 one or more user-specific embeddings of one or more types associated with respective users of the recommendation system 180. As mentioned above, the server 112 may be configured to use the one or more MLAs of the recommendation system 180 for generating user-specific embeddings (of different types) and may then store them in the database 120 for further processing. For example, the server 112 may be configured to generate and store user-specific embeddings in off-line mode of the recommendation system 180, and then retrieve them for further processing during the on-line mode of the recommendation system 180.

In some embodiments of the present technology, the database 120 may also be configured to store information about interactions between digital content items and users, hereinafter referred to as user-item interaction data 204. For example, the server 112 may track and gather a variety of different user-item interactions between users and previously recommended items.

For example, let it be assumed that a given user interacted with a given digital content item being a given digital document previously recommended thereto via the recommendation service. As such, the server 112 may track and gather user-item interaction data of the given user with the given digital document in a form of user events that occurred between the given user and the given digital item. Examples of different types of user events that may be tracked and gathered by the server 112 may include, but are not limited to:
the given user “scrolled over” the given digital item;
the given user “liked” the given digital item;
the given user “disliked” the given digital item;
the given user “shared” the given digital item;
the given user “clicked” or “selected” the given digital item;
the given user spent an amount of “interaction time” consulting the given digital item; and
the given user purchased/ordered/downloaded the given digital item.

As previously alluded to, the server 112 may make use of user-item interaction data 204 as input data into the SVD based MLA 160 (and SVD based MLA 165) for generating item-specific embeddings of collaborative type and user-specific embeddings of collaborative type. With reference to FIG. 3, there is depicted a representation 300 of how the SVD based MLA 160 is used by the server 112 for generating one or more embeddings of collaborative type. As it will become apparent from the description herein further below, the SVD based MLA 165 may be used in a similar manner, but based on different (content-based) input data, for generating user-specific embeddings of content type.

As seen, the server 112 may be configured to apply the SVD based MLA 160 onto a user-item interaction matrix 302 in order to generate an item collaborative embedding 310 (item-specific embedding of collaborative type) and a user collaborative embedding 320 (user-specific embedding of collaborative type).

It should be noted that in some embodiments of the present technology, the server 112 may be configured to generate more than one user embedding for the user 102. This means that the server 112 may be configured to input into the SVD based MLA 165 a matrix containing user-item interaction data and a predicted collaborative embedding for a given item for generating/reconstructing an other user embedding for the user 102.

It is contemplated that in some embodiments of the present technology, the item collaborative embedding 310 for a given item, and the one or more user embeddings (including the user collaborative embedding 320) may be generated by the server 112 an off-line mode. For example, the server 112 may be configured to generate and store in the database 120, the item collaborative embedding 310 for a given item, and the one or more user embeddings, prior to the receipt of the request 150 by the server 112 from the electronic device 104.

It should be noted that the SVD based MLA 160 is able to generate respective item collaborative embeddings for items that are associated with a sufficient amount user-item interaction data. It is contemplated that the server 112 may be configured to generate a plurality of item collaborative embeddings, similarly to what has been described with reference to FIG. 3, for items associated with sufficient amount user-item interaction data. The server 12 may use the SVD based MLA 160 to generate a plurality of user collaborative embeddings (based on user-item interaction data) and the other SVD based MLA 165 to generate a plurality of other user embeddings (based on content data). The server 112 may also be configured to store (in the off-line mode, for example) in the database 120 the plurality of item collaborative embeddings in association with respective items, the plurality of user collaborative embeddings and the plurality of other user embeddings in association with respective users.

With reference to FIG. 4, there is depicted a representation 400 of a single training iteration of the TL based MLA 170 (at the top of FIG. 4), and a representation 450 of a single in-use iteration of the TL based MLA 170 (at the bottom of FIG. 4). How the server 112 is configured to perform the training iteration of the TL based MLA 170 and how the server 112 is configured to perform the in-use iteration of the TL based MLA 170 170 will now be described in turn.

However, it is contemplated that the server 112 may be configured to perform a large number of training iterations in a similar manner to the single training iteration of FIG. 4 based on respective training datasets. Needless to say, the server 112 may also be configured to perform a large number of in-use iterations in a similar manner to the single in-use iteration of FIG. 4 based on respective in-use data.

The server 112 is configured to generate a training set 402 for a training item 401. In fact, the server 112 may be configured to generate a large number of training sets for respective training items in order to perform respective training iterations of the TL-type MLA 170. To that end, the server 112 may be configured to generate a target (item) collaborative embedding 410 for the training item 401 based on previous user interactions between the users of the content recommendation system 180 and the training item 401. For example, the server 112 may be configured to use the SVD based MLA 160 of FIG. 3 to generate the target collaborative embedding 410 for the training item 401, similarly to what has been described above.

As previously alluded to, it should be noted that the previous user interactions between the users and the training item 401 are sufficient for the SVD based MLA 160 to be able to generate the target collaborative embedding 410. As such, it is contemplated that the server 112 may be configured to generate the large number of training sets for respective training items for which previous user interactions stored in the database 120 are sufficient for generating the respective target collaborative embeddings. In other words, the server 112 may further be configured to identify which items should be used as training items for generating the large number of training sets.

It should also be noted that, in addition to the target collaborative embedding 410, the training set 402 further comprises information about the training item 401. More particularly, the training set 402 may further comprise content-based information about the training item 401. For example, the training set 402 may also comprise raw textual data associated with the training item 401 and where this raw textual data 415 is representative of the content of the training item 401.

The server 112 is configured to use the information about the training item 401 (the raw textual data 415) as a training input into the TL based MLA 170 for the given training iteration and use the target collaborative embedding 410 as a training target for the given training iteration.

In other words, the server 112 may be configured to input the raw textual data 415 into the TL based MLA 170, and which is configured to generate a predicted collaborative embedding 430 for the training item 401. Then, the server 112 is configured to compare the predicted collaborative embedding 430 against the target collaborative embedding 410 (prediction vs. target). As such, the server 112 is configured to determine a penalty score 440 between the target collaborative embedding 410 (generated by the SVD based MLA 160) and the predicted (item) collaborative embedding 430 (generated by the TL based MLA 170).

It should be noted that the penalty score 440 is indicative of a similarity between the predicted collaborative embedding 430 and the target collaborative embedding 410. The type of comparison metric used for evaluating the similarity between the predicted collaborative embedding 430 and the target collaborative embedding 410 is not particularly limiting. Nevertheless, irrespective of a particular type of comparison metric used for generating the penalty score 440, the server 112 is configured to use the penalty score 440 for adjusting the TL based MLA 170 during the given training iteration. For example, the server 112 may determine the penalty score 440 and employ a backpropagation technique in order to “adjust” the TL based MLA 170 for making better future predictions.

As such, by performing a large number of training iterations on the TL based MLA 170, the TL based MLA 170 in a sense “learns” to generate predicted collaborative embeddings for respective training items based on their content such that they are as similar as possible to the target collaborative embeddings for the respective training items. Put another way, the server 112 may be configured to adjust the TL based MLA 170 by using penalty scores during respective training iteration so as to increase the similarity between the predictions and the targets.

Developers of the present technology have realized that so-training the TL based MLA 170 to generate predicted collaborative embeddings based on content from a respective item so that they are similar to the respective target collaborative embeddings may allow the server 112 to predict a given collaborative embedding for a given in-use item when an insufficient amount of user-item interaction data is available for generating a respective collaborative embedding via the SVD based MLA 160. However, in other embodiments, the prediction of a collaborative embedding for a given in-use item may also be performed even if the amount of user-item interaction data is sufficient for generating the respective collaborative embedding via the SVD based MLA 160. As such, as it will become apparent from the description herein further below, in some embodiments where the user-item interaction data is sufficient for generating the collaborative item embedding via SVD based MLA 160, a first parameter may be generated by the server 112 for the given in-use item based on a collaborative user embedding and a collaborative item embedding (from the SVD based MLA 160), and a second parameter may be generated for the given in-use item based on a (reconstructed) user embedding (e.g., from the SVD based MLA 165) and the predicted collaborative item embedding (e.g., from the TL based MLA 170), and both the first parameter and the second parameter may be used by the server 112 as input into a relevance prediction model (e.g., the decision-tree based MLA 140) for ranking the given in-use item.

To better illustrate this, the representation 490 on FIG. 4 depicts a given in-use iteration of the TL based MLA 170. Let it be assumed that the database 120 stores an insufficient amount of user-item interactions for the in-use item 411. This means that the SVD based MLA 160 may not be able to generate a respective collaborative embedding for that in-use item 411 (due to sparseness of data, for example). As such, the server 112 may be configured to access the database 120 for determining raw textual data 465 associated with the in-use item 411 and use the raw textual data 465 as input for the so-trained TL based MLA 170.

As explained above, the so-trained TL based MLA 170 is thus configured to output a predicted collaborative embedding 480 for the in-use item 411. Hence, the server 112 may use the predicted collaborative embedding 480 for the in-use item 411 as an estimation of a given collaborative embedding that the SVD based MLA 160 may not be otherwise able to generate based on the amount of user-interaction data stored for the in-use item 411 in the database 120.

It should be noted that the server 112 may be configured to use the TL based MLA 170 during its in-use phase, during the off-line mode, for generating a plurality of predicted item collaborative embeddings for items associated with a limited amount of user-item interaction data (that is, an amount of user-item interaction data that is insufficient for the SVD based MLA 160 to otherwise generate a respective item collaborative embedding). The server 112 may also be configured to store the plurality of predicted item collaborative embeddings in the database 112 in association with respective items.

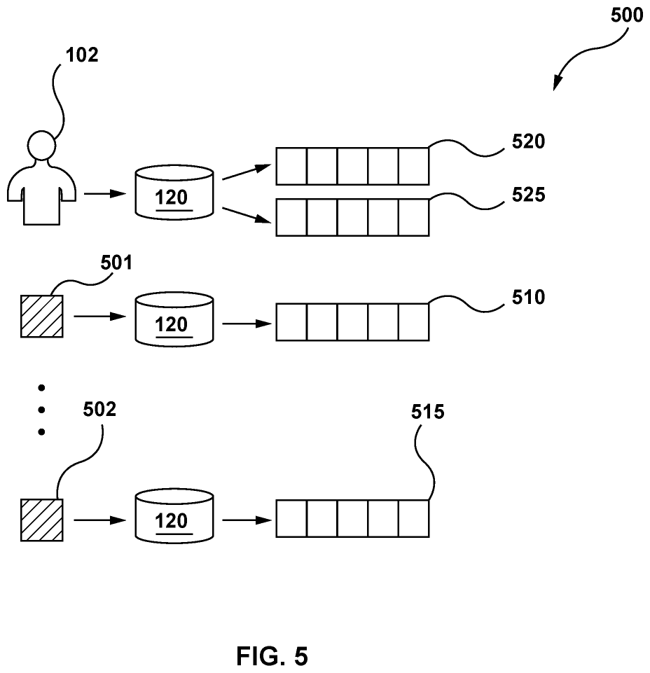

With reference to FIG. 5, there is depicted a representation 500 of how the server 112 may be configured to access the database 120 during the on-line mode of the recommendation system 180 for providing content recommendation to the user 102.

Let it be assumed that a plurality of items (not numbered) are selected by the server 112 as items that might be of interest to the user 102, including a first item 501 and a second item 502. The server 112 is configured to access the database 120 to retrieve item collaborative embeddings for respective ones of the plurality of items. As such, the server 112 is configured to access the database 120 to retrieve a first item collaborative embedding 510 that has been generated by the SVD based MLA 160 before being stored in the database 120.

The server 112 may also configured to access the database 120 to retrieve a given item collaborative embedding for the second item 502. However, instead of the given item collaborative embedding, the database 120 may be storing a predicted item collaborative embedding 515 for the second item 502. Indeed, let it be assumed that the second 502 is associated with insufficient amount of user-item interaction data for the SVD based MLA 160 to generate the given item collaborative embedding. As such, the server 112 may have used the TL based MLA 170 in order to generate the predicted item collaborative embedding 525, as explained above.

Also, the server 112 is configured to retrieve one or more user embeddings associated with the user 102. For example, the server 112 may be configured to access the database 120 and retrieve a user collaborative embedding 520 having been generated by the SVD based MLA 160 and an other user embedding 525 having been generated by the other SVD based MLA 165.

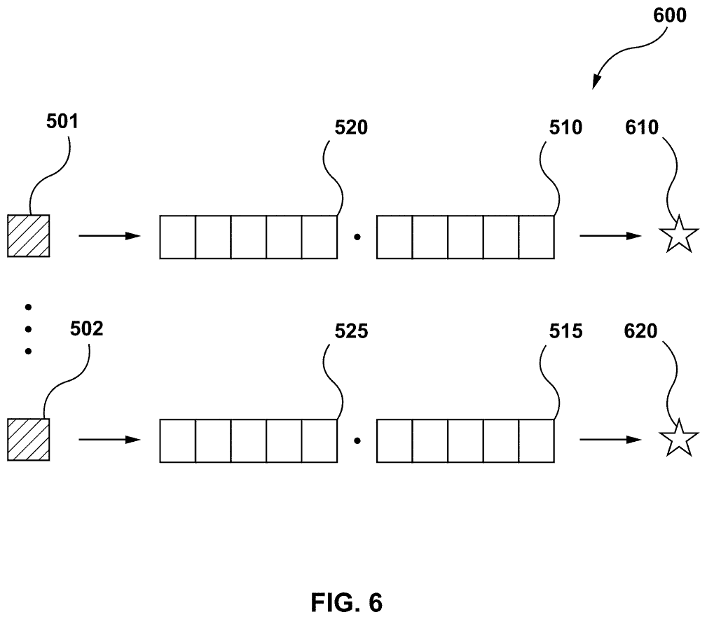

In at least some non-limiting embodiments of the present technology, the server 112 may be configured to employ one or more embeddings retrieved from the database 120 in order to generate parameters for further ranking the first item 501 and the second item 502. With reference to FIG. 6, there is depicted a representation 600 of how the server 112 may be configured to generate a first parameter 610 for the first item 501 and a second parameter 620 for the second item 502.

As seen, the server 112 may be configured to generate the first parameter 610 for the first item 501 as a product of the user collaborative embedding 520 and the item collaborative embedding 510. The server 112 may also be configured to generate the second parameter 620 for the second item 502 as a product of the other user embedding 525 and the predicted item collaborative embedding 515. In some embodiments, the server 112 may be configured to generate the second parameter 620 for the second item 502 as a product of the user collaborative embedding 520 and the predicted item collaborative embedding 515.

In some embodiments, the server 112 may be configured to compute the product as a dot product of two vectors. In other embodiments, the product may be representative of a Euclidian distance between the two vectors. In further embodiments, it can be said that the result of the product (i.e., a given parameter) is indicative of how similar, or how dissimilar, the two vectors are to one another.

With reference to FIG. 7, there is depicted a representation 700 of how the server 112 is configured to employ the decision-tree based MLA 140 in order to generate a ranked list of items 780 for the user 102. As seen, the server 112 may input into the decision-tree based MLA 140 user feature data 702. For example, the server 112 may access the database 120 and retrieve information associated with the user 102 and stored as part of the user data 206.

The server 112 may also input for the first item 501 item data 704 and the first parameter 610. For example, the server 112 may be configured to access the database 120 and retrieve information associated with the first item 501 and stored as part of the item data 202. The server 112 may also input for the second item 502 item data 706 and the second parameter 620. For example, the server 112 may be configured to access the database 120 and retrieve information associated with the second item 502 and stored as part of the item data 202. The decision-tree based MLA 140 is configured to generate, as an output, the ranked list of recommendation items 780 that are ranked based on their relevance to the user 102.

In some embodiments of the present technology, the server 112 may be configured to use one or more items from the ranked list of recommendation items 780 as content recommendation for the user 102. For example, the server 112 may use at least some of the ranked list of recommendation items 780 for generating the recommended digital content set 814 depicted in FIG. 8. Indeed, the first recommended digital document 816 and the second recommended digital document 818 may include content of the first item 501 and the second item 502, respectively.

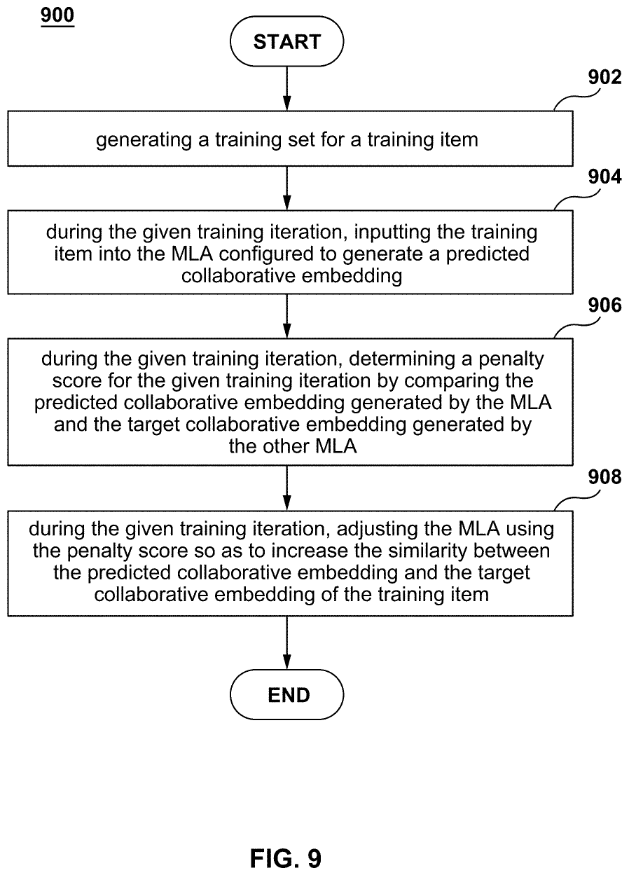

Turning now to FIG. 9, there is depicted a schematic block diagram depicting a flow chart of a method 900 of training the TL based MLA 170 to generate a given predicted collaborative embedding for an in-use item. Various steps of the method 900 will now be described in greater detail. It should be noted that in some embodiments, at least some of the steps of the method 900 may be omitted, replaced or additional steps may be executed to those listed below as part of the method 900, without departing from the scope of the present technology.

### Step 902: Generating a Training Set for a Training Item

The method 900 begins at step 902 with the server 112 configured to generate a given training set for a training item. For example, the server 112 may be configured to generate the training set 402 (see FIG. 4) for the training item 401. In some embodiments, the server 112 may be configured to generate a large number of training sets for respective training items in order to perform respective training iterations of the TL based MLA 170.

It should be noted that generating the training set 402 may comprise the server 112 configured to generate the target (item) collaborative embedding 410 for the training item 401 based on previous interactions between the users and the training item 401. For example, the server 112 may be configured to use the SVD based MLA 160 of FIG. 3 to generate the target collaborative embedding 410 for the training item 401, similarly to what has been described above.

It should be noted that the previous user interactions between the users and the training item 401 are sufficient for the SVD based MLA 160 to be able to generate the target collaborative embedding 410. As such, it is contemplated that the server 112 may be configured to generate the large number of training sets for respective training items for which previous user interactions stored in the database 120 are sufficient for generating the respective target collaborative embeddings. In other words, the server 112 may further be configured to identify which items should be used as training items for generating the large number of training sets.

It should also be noted that, in addition to the target collaborative embedding 410, the training set 402 further comprises information about the training item 401. More particularly, the training set 402 may further comprise content-based information about the training item 401. For example, the training set 402 may comprise the training item 401 and/or the raw textual data 415 from the training item 401 representative of the content of the training item 401. In some embodiments, the raw textual data 415 may be determined by the server 112 by parsing the training item 401 and extracting the raw textual data 415 from the training item 401.

In at least some non-limiting embodiments of the present technology, it can be said that the training set 402 includes a item-specific embedding of collaborative type and raw textual data, both associated with a common training item for which sufficient user-item interaction data is available for generating the item-specific embedding of collaborative type.

It can also be said that, in some embodiments, a given training iteration of the TL based MLA 170 is based on data associated with a single training item. For example, instead of performing a training iteration based on information from more than one item, the TL based MLA 170 can be trained based on item-specific training sets (as opposed to multi-item based training sets, for example). It should be noted that training the TL based MLA 170 based on single-item training sets (as opposed to multi-item training sets) may allow the server 112 to reduce computational resources required during the training phase as well as the in-use phase of the TL based MLA 170.

Step 904: During the Given Training Iteration, Inputting the Training Item into the MLA Configured to Generate a Predicted Collaborative Embedding

The method 900 continues to step 904 with the server 112 configured to input during a given training iteration the training item 401 into the TL based MLA 170 and the TL based MLA 170 is configured to generate a predicted item collaborative embedding 430 for the training item 401. For example, the training item 401 may comprise the raw textual data 415 which can be used as a training input into the TL based MLA 170.

### Step 906: During the Given Training Iteration, Determining a Penalty Score for the Given Training Iteration by Comparing the Predicted Collaborative Embedding Generated by the MLA and the Target Collaborative Embedding Generated by the Other MLA

The method 900 continues to step 906 with the server 112 configured to determine the penalty score 440 for the given training iteration by comparing the predicted item collaborative embedding 430 generated by the TL based MLA 170 and the target item collaborative embedding 410 generated by the SVD based MLA 160. The penalty score 440 is indicative of a similarity between the predicted item collaborative embedding 430 and the target item collaborative embedding 410.

The type of comparison metric used for evaluating the similarity between the predicted collaborative embedding 430 and the target collaborative embedding 410 is not particularly limiting. Nevertheless, irrespective of a particular type of comparison metric used for generating the penalty score 440, the server 112 is configured to use the penalty score 440 for adjusting the TL based MLA 170 during the given training iteration.

Step 908: During the Given Training Iteration, Adjusting the MLA Using the Penalty Score so as to Increase the Similarity between the Predicted Collaborative Embedding and the Target Collaborative Embedding of the Training Item

The method 900 continues to step 908 with the server 112 configured to, during the given training iteration, adjust the TL based MLA 170 using the penalty score 440 so as to increase the similarity between predicted item collaborative embeddings and the target item collaborative embeddings. For example, the server 112 may determine the penalty score 440 and employ a backpropagation technique in order to “adjust” the TL based MLA 170 for making better future predictions.

As such, by performing a large number of training iterations on the TL based MLA 170, the TL based MLA 170 in a sense “learns” to generate predicted collaborative embeddings for respective training items based on their content such that they are as similar as possible to the target collaborative embeddings for the respective training items. Put another way, the server 112 may be configured to adjust the TL based MLA 170 by using penalty scores during respective training iteration so as to increase the similarity between the predictions and the targets.

Developers of the present technology have realized that so-training the TL based MLA 170 to generate predicted collaborative embeddings based on content from a respective item so that they are similar to the respective target collaborative embeddings may allow the server 112 to predict a given collaborative embedding for a given in-use item when as insufficient amount of user-item interaction data is available for generating a respective collaborative embedding via the SVD based MLA 160.

In some embodiments, the method 900 may further comprise the server 112 configured to receiving an indication of a request for content recommendation from the user 102 of the content recommendation system 180. For example, the server 112 may receive the request 150 from the electronic device 104. The server 112 may also be configured to determine a plurality of potential recommendation items to be provided to the user 102. For example, the server 112 may determine the plurality of recommendation items including the first item 501 and the second item 502 (see FIG. 5). For example, this plurality of recommendation items may include a set of items associated with previous user interactions between the users and the respective items from the set of items. In this case, the set of items includes the first item 501. The plurality of recommendation items also includes at least one other item associated with limited user-item interaction data, such as the second item 502, for example.

The server 112 may also be configured to acquire item collaborative embeddings for the respective items from the set of items. For example, the server 112 may be configured to retrieve inter alia the item collaborative embedding 510 for the first item 501 from the database 120. It can be said that item collaborative embedding 510 has been determined by the SVD based MLA 160 based on previous user interactions between the users and the first item 501 and where they were sufficient for determining the pre-determined collaborative embeddings for the respective items by the SVD based MLA 160.

It should be noted that the SVD based MLA 160 may have been unable to determine a given item collaborative embedding for the second item 502 due to a limited amount of user interactions between the second item 502 and the users of the system 180. The server 112 may also be configured to acquire the predicted item collaborative embedding 515 for the second item 502. For example, the server 112 may be configured to retrieve the predicted item collaborative embedding 515 from the database 120.

The server 112 may also be configured to acquire the user collaborative embedding 520 for the user 102. For example, the server 112 may be configured to retrieve the user collaborative embedding 520 from the database 120. The user collaborative embedding has been determined (and then stored in the database 120) by the SVD based MLA 160 based on the previous user interactions between the user 102 and the items from the set of items.

The server 112 may also be configured to acquire the other user embedding 525 for the user 102. For example, the server 112 may be configured to retrieve the other user embedding 525 from the database 120. The other user embedding 525 has been determined (and then stored in the database 120) by the other SVD based MLA 165 based on user-item interaction data and the predicted collaborative embedding 515. In one non-limiting example, the user-item interaction data and the predicted collaborative embedding 515 may be used by the other SVD based MLA 165 in order to generate (by performing one Alternate Least Square (ALS) iteration, for example) the other user embedding 525 that is then stored in the database 120 by the server 112.

The server 112 may also be configured to generate the second parameter 620 for the second item 502 as a product of (i) the predicted collaborative embedding 515 and (ii) the other user embedding 525. The second parameter 620 may be used by the server 112 as an input into the decision-tree based MLA 140 configured to rank the plurality of potential recommendation items. The server 112 may also be configured to generate the first parameter 610 for the first item 501 from the set of items as a product of (i) the respective item collaborative embedding 510, and (ii) the user collaborative embedding 520. The first parameter 610 may also be used by the server 112 as input into the decision-tree based MLA 140 configured to rank the plurality of potential recommendations items.

It should be noted that the item collaborative embedding 510, the predicated item collaborative embedding 515, the user collaborative embedding 520, and the other user embedding 525 may have been determined and stored in the off-line mode of the recommendation system 180. For example, the item collaborative embedding 510 may have been determined by the SVD based MLA 160 prior to the receipt of the request 150, the predicated item collaborative embedding 515 may have been determined by the TL based MLA 170 prior to the receipt of the request 150, the user collaborative embedding 520 may have been generated by the SVD based MLA 160, and the other user embedding 525 may have been generated by the other SVD based MLA 165.

In some embodiments of the present technology, it is contemplated that even if the server 112 can generate a given item collaborative embedding for a given item using the SVD based MLA 160, the server 112 may still be configured to generate a respective predicted item collaborative embedding for that item. The server 112 may acquire raw textual data (content data) associated with the given item and input it into the (trained) TL based MLA 170 that is configured to output the respective predicted item collaborative embedding. In the case of the first item 501, for example, the server 112 may be configured to generate, by the server, an other parameter for the first item 501 as a product of (i) the predicted item collaborative embedding for the first item 501 (instead of the item collaborative embedding 510) and (ii) the other user embedding 525. The server 112 may also be configured to use the other parameter in addition to or instead of the first parameter 610 as input into the decision-tree based MLA 170 as explained above.

In some embodiments, it should be noted that the SVD based MLA 160 can be trained on a given plurality of training sets. The training item 401 may be used in a second plurality of training sets that is smaller than the given plurality of training sets. In other words, the SVD based MLA 160 may be trained on a larger number of training sets than the number of training sets used for training the TL based MLA 170.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature-based, or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for training a Machine Learning Algorithm (MLA) to generate a predicted collaborative embedding for a digital item, the digital item being a potential recommendation item of a content recommendation system, the content recommendation system configured to recommend items to users of the content recommendation system, the content recommendation system being hosted by a server, the method executable by the server, the method comprising:
generating, by the server, a training set for a training item, the generating including:
generating, by the server employing an other MLA, a target collaborative embedding for the training item based on previous user interactions between the users of the content recommendation system and the training item,
the previous user interactions between the users and the training item being sufficient for generating the target collaborative embedding; and
the training set comprising the target collaborative embedding and the training item,
the training item being a training input for a given training iteration and the target collaborative embedding being a training target for the given training iteration;
during the given training iteration:
inputting, by the server, the training item into the MLA, the MLA being configured to generate a predicted collaborative embedding for the training item;
determining, by the server, a penalty score for the given training iteration by comparing the predicted collaborative embedding generated by the MLA and the target collaborative embedding generated by the other MLA,
the penalty score being indicative of a similarity between the predicted collaborative embedding and the target collaborative embedding of the training item; and
adjusting, by the server, the MLA using the penalty score so as to increase the similarity between the predicted collaborative embedding and the target collaborative embedding of the training item.

2. The method of claim 1, wherein the inputting the training item comprises inputting, by the server, raw textual data of the training item.

3. The method of claim 2, wherein the method further comprises determining, by the server, the raw textual data based on content of the training item.

4. The method of claim 1, wherein the other MLA is a Singular Value Decomposition (SVD) based MLA.

5. The method of claim 1, wherein the method further comprises:
acquiring, by the server, an indication of a request for content recommendation from a given user of the content recommendation system;
determining, by the server, a plurality of potential recommendation items to be provided to the given user, the plurality of potential recommendation items including:
(i) a set of items associated with previous user interactions between the users and the respective items from the set of items, and
(ii) at least one other item, the at least one other item including the digital item;
acquiring, by the server, a collaborative embedding for a given from the set of items,
the collaborative embedding having been determined by the other MLA based on the previous user interactions between the users and the given item from the set of items,
the previous user interactions between the users and the given item having been sufficient for determining the collaborative embedding for the given item by the other MLA;
acquiring, by the server, a predicted collaborative embedding for the digital item;
acquiring, by the server, a user collaborative embedding for the given user, the user collaborative embedding having been determined by the other MLA based on the previous user interactions between the user and the items from the set of items;
acquiring, by the server, an other user embedding for the given user, the other user embedding having been determined by a second other MLA based on the predicted collaborative embedding for the digital item and user interactions between the given user and items of the recommendation system;
generating, by the server, a parameter for the digital item as a product of (i) the predicted collaborative embedding of the digital item and (ii) the other user embedding, the parameter being an input into a third MLA configured to rank the plurality of potential recommendation items; and
generating, by the server, a second other parameter for the given item from the set of items as a product of (i) the respective collaborative embedding, and (ii) the user collaborative embedding, the second other parameter being an input into the third MLA configured to rank the plurality of potential recommendations items.

6. The method of claim 5, wherein the collaborative embedding has been determined by the other MLA in an off-line mode, prior to receipt of the indication of the request for content recommendation.

7. The method of claim 5, wherein the third MLA is a decision-tree based MLA.

8. The method of claim 5, wherein the method further comprises:
acquiring, by the server, an other predicted collaborative embedding for a given item for the set of items, the other predicted collaborative embedding having been generated by the MLA based on content data associated with the given item;
generating, by the server, an other parameter for the given item as a product of (i) the other predicted collaborative embedding of the given item and (ii) the other user embedding, the other parameter being an input into the third MLA configured to rank the plurality of potential recommendation items.

9. The method of claim 1, wherein the other MLA is trained on a plurality of training sets.

10. The method of claim 9, wherein the training item is used in a second plurality of training sets, and wherein the plurality of training sets is larger than the second plurality of training sets.

11. A server for training a Machine Learning Algorithm (MLA) to generate a predicted collaborative embedding for an digital item, the digital item being a potential recommendation item of a content recommendation system, the content recommendation system configured to recommend items to users of the content recommendation system, the content recommendation system being hosted by the server, the server being configured to:
generate a training set for a training item, to generate comprises the server configured to:
generate, by employing an other MLA, a target collaborative embedding for the training item based on previous user interactions between the users of the content recommendation system and the training item,
the previous user interactions between the users and the training item being sufficient for generating the target collaborative embedding; and
the training set comprising the target collaborative embedding and the training item,
the training item being a training input for a given training iteration and the target collaborative embedding being a training target for the given training iteration;
during the given training iteration:
input the training item into the MLA, the MLA being configured to generate a predicted collaborative embedding for the training item;
determine a penalty score for the given training iteration by comparing the predicted collaborative embedding generated by the MLA and the target collaborative embedding generated by the other MLA,
the penalty score being indicative of a similarity between the predicted collaborative embedding and the target collaborative embedding of the training item; and
adjust the MLA using the penalty score so as to increase the similarity between the predicted collaborative embedding and the target collaborative embedding of the training item.

12. The server of claim 11, wherein the input the training item comprises the server configured to input raw textual data of the training item.

13. The server of claim 12, being further configured to determine the raw textual data based on content of the training item.

14. The server of claim 11, wherein the other MLA is a Singular Value Decomposition (SVD) based MLA.

15. The server of claim 11, being further configured to:
acquire an indication of a request for content recommendation from a given user of the content recommendation system;
determine a plurality of potential recommendation items to be provided to the given user, the plurality of potential recommendation items including:
(iii) a set of items associated with previous user interactions between the users and the respective items from the set of items, and
(iv) at least one other item, the at least one other item including the digital item;
acquire a collaborative embedding for a given item from the set of items,
the collaborative embedding having been determined by the other MLA based on the previous user interactions between the users and the given item from the set of items,
the previous user interactions between the users and the given item having been sufficient for determining the collaborative embedding for the given item by the other MLA;
acquire a predicted collaborative embedding for the digital item;
acquire a user collaborative embedding for the given user, the user collaborative embedding having been determined by the other MLA based on the previous user interactions between the user and the items from the set of items;
acquire an other user embedding for the given user, the other user embedding having been determined by a second other MLA based on the predicted collaborative embedding for the digital item and user interactions between the given user and items of the recommendation system;
generate a parameter for the digital item as a product of (i) the predicted collaborative embedding of the digital item and (ii) the other user embedding, the parameter being an input into a third MLA configured to rank the plurality of potential recommendation items; and
generate an other parameter for the given item from the set of items as a product of (i) the respective collaborative embedding, and (ii) the user collaborative embedding, the other parameter being an input into the third MLA configured to rank the plurality of potential recommendations items.

16. The server of claim 15, wherein the collaborative embedding has been determined by the other MLA in an off-line mode, prior to receipt of the indication of the request for content recommendation.

17. The server of claim 15, wherein the third MLA is a decision-tree based MLA.

18. The server of claim 15, wherein the server is further configured to:
acquire an other predicted collaborative embedding for a given item for the set of items, the other predicted collaborative embedding having been generated by the MLA based on content data associated with the given item;
generate a second other parameter for the given item as a product of (i) the other predicted collaborative embedding of the given item and (ii) the other user embedding, the second other parameter being an input into the third MLA configured to rank the plurality of potential recommendation items.

19. The server of claim 11, wherein the other MLA is trained on a plurality of training sets.

20. The server of claim 19, wherein the training item is used in a second plurality of training sets, and wherein the plurality of training sets is larger than the second plurality of training sets.
